(19) United States
(12) Patent Application Publication
(10) Pub. No.: US 2006/0069480 A1
(43) Pub. Date: Mar. 30, 2006

(54) Apparatus and method for controlling vehicular motion

(75) Inventor: Yutaka Hiwatashi, Tokyo (JP)

Correspondence Address: SMITH, GAMBRELL & RUSSELL, LLP, 1850 M STREET, N.W., SUITE 800, WASHINGTON, DC, 20036, US

(73) Assignee: Fuji Jukogyo Kabushiki Kaisha

(21) Appl. No.: 11/234,269

(22) Filed: Sep. 26, 2005

(30) Foreign Application Priority Data
Sep. 30, 2004 (JP) 2004-286031

(51) Int. Cl. G06F 19/00

(52) U.S. Cl. 701/41; 701/1

(57) ABSTRACT

Based on the detected lengthwise forces Fx, a moment M around a vertical line passing through the center of gravity of the vehicle is calculated, the moment being produced around the vehicle by a difference between the driving forces acting on the left and right wheels. A steering angle δf of the wheel varying the state of motion of the vehicle is identified so as to reduce the calculated moment M. This steering angle δf is set as a target steering angle δf*. Based on the set target steering angle δf*, the steering angle of the wheel is controlled.

### CROSS REFERENCE TO RELATED APPLICATIONS

The disclosure of Japanese Application No. 2004-286031 filed on Sep. 30, 2004, including the specification, drawings and abstract, is incorporated herein by reference in its entirety.

### FIELD OF THE INVENTION

The present invention relates to apparatus and method for controlling vehicular motion, preferably the steering angle of the wheel is controlled.

### BACKGROUND OF THE INVENTION

Techniques for controlling a vehicle based on a vehicle model obtained by modeling the state of motion of the vehicle in order to improve steering and stability have been heretofore known. Such a vehicle model has been obtained by modeling yaw motion, lateral motion, or rolling motion of a vehicle under some circumstances of operation through experiments or simulations. The model can be calculated based on equations of motion for vehicles. For example, apparatuses for controlling states of motion of vehicles based on vehicle models are disclosed in Japanese Patent Laid-Open No.9-109866, and No.2000-335271.

When a driver starts a vehicle or applies the brake, a difference may be produced between the driving forces at the left and right wheels according to road surface conditions. In the case that the steering wheel is mechanically linked to the wheel, the steering wheel may be forcedly rotated to the left or right due to the difference between the driving forces. As the result, the driver has an unnatural feeling during manipulation. Furthermore, this difference generates a moment around the center of gravity of the vehicle. This varies the state of the vehicle. In some cases, the vehicle may spin.

### SUMMARY OF THE INVENTION

Accordingly, it is an object of the present invention to provide apparatus and method for appropriately controlling the state of motion of a vehicle according to the difference in driving force between the left and right wheels.

To achieve this object, a first aspect of the present invention provides a vehicular motion control apparatus having a detection portion for detecting lengthwise forces respectively acting on left and right wheels mounted to a vehicle, a calculation portion for calculating the present value of a moment around a vertical line passing through the center of gravity of the vehicle based on the detected lengthwise forces, the moment being produced around the vehicle by a difference in driving force between the left and right wheels, a setting portion for identifying the steering angle of the wheel varying state of motion of the vehicle such that the moment produced around the vehicle approaches 0 from the calculated present value and setting the steering angle as a target steering angle, and a steering road wheel control portion for controlling the steering angle of the wheel based on the set target steering angle.

In the first aspect of the invention, the setting portion preferably has parameters including at least the steering angle and calculates a steering angle becoming a component canceling the present value of the moment as the target steering angle based on a vehicle model obtained by modeling the state of motion of the vehicle. In this case, the setting portion may calculate the target steering angle using an algebraic formula in which the number of the parameters constituting the vehicle model has been reduced by approximating the vehicle model.

Furthermore, in the first aspect of the invention, plural road wheel speed sensors for detecting the speeds of the wheel, respectively, may be further incorporated. The speeds of the wheel are one kind of the parameters constituting the vehicle model. In this case, when the vehicle is braking, the setting portion preferably calculates the target steering angle using a maximum speed value of the speeds detected by the road wheel speed sensors. When the vehicle starts, the setting portion calculates the target steering angle using a minimum speed value of the speeds detected by the road wheel speed sensors.

A second aspect of the present invention provides a method of controlling motion of a vehicle, the method comprising first through fourth steps. The first step consists of detecting lengthwise forces respectively acting on left and right wheels mounted to the vehicle. The second step consists of calculating the present value of a moment around a vertical line passing through the center of gravity of the vehicle based on the detected lengthwise forces, the moment being produced around the vehicle by a difference in driving force between the left and right wheels. The third step consists of identifying the steering angle of the wheel varying the state of motion of the vehicle such that the moment produced around the vehicle approaches 0 from the calculated present value and setting the steering angle as a target steering angle. The fourth step consists of controlling the steering angle of the wheel based on the set target steering angle.

According to the present invention, the lengthwise forces acting on the wheel are directly detected. Therefore, the moment around the center of gravity can be identified more accurately than in cases where the lengthwise forces are estimated or where they are detected using an indirect technique. The steering angle of the wheel is controlled so that the moment around the center of gravity approaches 0 from the present value of the identified moment. Therefore, the moment acts in the direction to stabilize the state of motion of the vehicle irrespective of the difference in driving forcing between the left and right wheels. Consequently, steering and stability can be improved. In addition, there is the advantage that it is possible to suppress occurrence of the phenomenon that the steering wheel is turned in a non-controlled manner due to a difference in driving force between the left and right wheels.

### BRIEF DESCRIPTION OF THE DRAWINGS

FIG. 1 is a block diagram of a vehicle utilizing a vehicular motion control apparatus according to a first embodiment of the present invention;

FIG. 2 is a diagram illustrating a force acting on a wheel;

FIG. 3 is a block diagram showing the configuration of the vehicular motion control apparatus;

FIG. 4 is a flowchart illustrating a control routine;

FIG. 5 is a diagram illustrating state of motion of a vehicle; and

FIG. 6 is a diagram illustrating a vehicle model obtained by modeling state of motion of a vehicle.

### DESCRIPTION OF THE PREFERRED EMBODIMENTS

### First Embodiment

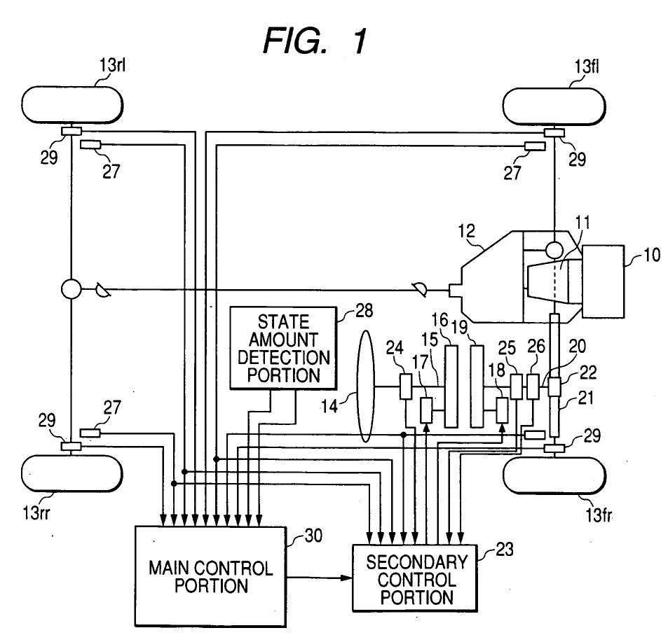

FIG. 1 illustrates a vehicle having a vehicular motion control apparatus according to the present embodiment. The vehicle has an engine 10 including a crankshaft. Power from the crankshaft is transmitted to drive axles on the front and rear wheel sides, respectively, via an automatic transmission 11 and a center differential 12. As power is transmitted to the drive axles, a turning torque is applied to front wheels 13fl, 13fr and rear wheels 13rl, 13rr. Consequently, the wheels 13fl to 13rr are rotated. A driving force is applied to the wheels 13fl-13rr. A force applied to the wheels 13fl-13rr may also be a braking force, as well as the driving force. The braking force can be considered as a reverse-directional component (negative component) of the driving force and so the driving force is meant to include the braking force. Furthermore, the wheels 13fl-13ff are collectively referred to simply as “wheel 13” herein.

In this four-wheel-drive vehicle, a steer-by-wire mechanism is installed in the steering mechanism that steers the wheel 13 (the front wheels 13fl and 13fr, in the present embodiment). In the steer-by-wire mechanism, the steering wheel 14 rotationally manipulated by the driver is mechanically isolated from the front wheels 13fl and 13fr.

The steering wheel 14 rotationally manipulated by the driver is fixedly attached to the front end of a steering input shaft 15. The lower end of the steering input shaft 15 is connected to a first power transfer mechanism 16. The output shaft of a first motor 17 is connected to the first power transfer mechanism 16. A power produced by the first motor 17 is transmitted as a steering reaction force to the steering wheel 14 via the first power transfer mechanism 16 and steering input shaft 15.

With respect to the front wheels 13fl and 13fr mechanically isolated from the steering wheel 14, the steering angle is set by a second motor 18 acting as a steering actuator. The output shaft of the second motor 18 is connected to a second power transfer mechanism 19. A steering output shaft 20 is connected to the second power transfer mechanism 19. A pinion 22 in mesh with a rack 21 is fixedly mounted to the lower-end portion of the steering output shaft 20, the rack being connected to the front wheels 13fl and 13fr. A power produced by the second motor 18 is transmitted to the steering output shaft 20 via the second power transfer mechanism 19. Thus, the pinion 22 is rotated, displacing the rack 21 axially. The steering angle of the front wheels 13fl and 13fr varies according to the axial displacement of the rack 21.

The operation of the first and second motors 17 and 18 is controlled by a wheel control portion (secondary control portion) 23. The relation between the angular position of the steering wheel and the steering angle of the steering wheels is arbitrarily set by the secondary control portion 23. To permit control of the operation of the motors 17 and 18, detection signals from various sensors 24-27 are input to the secondary control portion 23. The steering wheel angular position sensor 24 is mounted to the steering input shaft 15 and detects the rotational angle of the steering wheel 14 (e.g., rotational angle from the neutral position). The steering angle of wheel sensor 25 is mounted to the steering output shaft 20 and detects the angular position of the output shaft 20. Thus, the steering angle δf (rotational angle from the neutral position) of the left-hand right wheels 13fl and 13fr is detected. The torque sensor 26 is mounted to the steering output shaft 20 and detects the torque (road surface reaction torque) acting on the steering output shaft 20. The vehicle speed sensors 27 detect the vehicle speed v by detecting the speeds of the wheels 13 and are mounted respectively to the wheels 13fl-13rr.

In controlling the operation of the second motor 18, the secondary control portion 23 identifies a steering gear ratio based on the vehicle speed v. A steering gear ratio is usually set variably according to the vehicle speed v and uniquely identified by referring to a map in which the relation between both steering gear ratio and vehicle speed has been appropriately set through experiments or simulations. Then, a target steering angle δf* of the wheel is calculated based on the steering gear ratio and on the detected angle of the steering wheel. An amount by which the second motor 18 is controlled is calculated based on the calculated target steering angle δf* of the wheel and detected steering angle δf of the wheel (hereinafter referred to as the “actual steering angle of wheel”). The calculated amount for control is output to a driver circuit (not shown), which in turn operates the second motor 18. In consequence, the actual steering angle δf of the wheel is adjusted to the target steering angle δf* of the wheel.

On the other hand, in controlling the operation of the first motor 17, the secondary control portion 23 first refers to a coefficient table previously created through experiments or simulations and determines a torque coefficient corresponding to the vehicle speed v. Based on the determined torque coefficient and on the detected angular position of the steering wheel and reaction torque from the road surface, an amount by which the first motor 17 is controlled is determined. The calculated amount for control is output to a driver circuit (not shown), which in turn operates the first motor 17. Consequently, a reaction force corresponding to the present angle of the steering wheels is imparted to the steering wheel 14.

A main control portion 30 cooperates with the secondary control portion 23 to adjust the steering angle of the left and right front wheels 13fl and 13fr, thus controlling the state of motion. To detect the present state of operation of the vehicle, signals from the vehicle speed sensors 27, a state amount detection portion 28, and an acting force detection portion 29 are detected and input into the main control portion 30. The state amount detection portion 28 detects the amounts of states of the vehicle such as yaw rate γ and lateral acceleration (acceleration produced laterally of the vehicle) Yg.

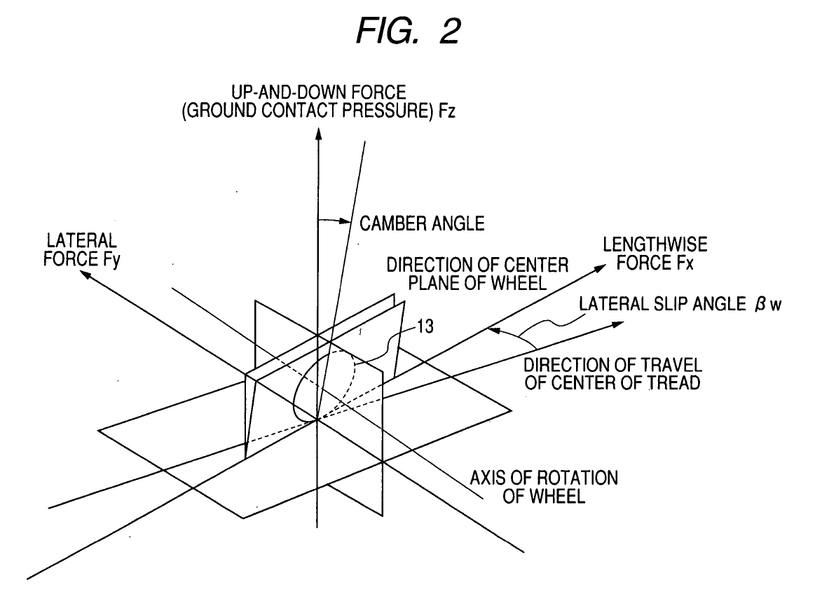

FIG. 2 illustrates the force acting on the wheel 13. The acting force detection portion 29 is a sensor for detecting the force acting on each wheel 13 and mounted either to an axle or to a member that supports the axle (hereinafter simply referred to as the “axle”) which supports any one of the wheels 13fl-13rr. A lengthwise force Fx is important as the acting force detected by the acting force detection portion 29. Besides, it can detect a lateral force Fy and an up-and-down force Fz. The lengthwise force Fx is a component of the frictional force produced at the road contact surface when the wheel 13 rotate at some wheel lateral skidding angle βw, the component being produced in a direction parallel to the wheel center plane. On the other hand, a component of the force that is produced in a direction perpendicular to the wheel center plane is the lateral force Fy. A load in the vertical direction is an up-and-down force Fz. This acting force detection portion 29 detects the stress acting on the axle based on the knowledge that stress produced in the axle is in proportion to the acting force. Thus, the acting force is directly detected. Therefore, the acting force detection portion 29 consists mainly of a strain gauge for detecting the stress produced in the axle and a signal-processing circuit that processes the electrical signal output from the strain gauge and creates a detection signal corresponding to the acting force. Furthermore, the acting force detection portion 29 can calculate the frictional coefficient μ of the road surface from the value detected by the detection portion 29 itself as the ratio between the frictional force at the road surface (i.e., lengthwise force Fx) and up-and-down force Fz. A specific configuration of the acting force detection portion 29 is disclosed in JP-A-04-3313336 and JP-A-10-318862. Therefore, if necessary, refer to them.

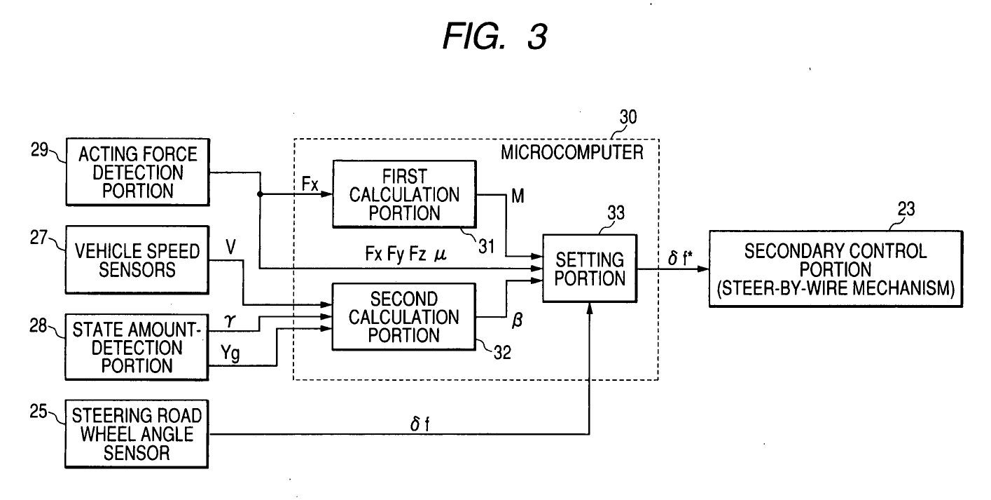

FIG. 3 is a block diagram showing the whole configuration of the vehicular motion control apparatus. A microcomputer mainly comprises a CPU, a ROM, a RAM, and input/output interfaces can be used as the main control portion 30. By expressing the control apparatus functionally, the main control portion 30 has a first calculation portion 31, a second calculation portion 32, and a setting portion 33. The first calculation portion 31 calculates the present value of moment M around a vertical line passing through the center of gravity of the vehicle, the moment being produced by the difference between a driving force given to the left wheels 13fl and 13rl and a driving force given to the right wheels 13fr and 13rr. The second calculation portion 32 calculates a computational parameter (lateral slip angle β of the vehicul body, in the present embodiment) necessary to calculate the target steering angle δf* of the wheel based on the detection signals from various sensors. The setting portion 33 sets the target steering angle δf* of the wheel to a value varying the state of motion of the vehicle such that the moment M around the center of gravity approaches 0 from the present value.

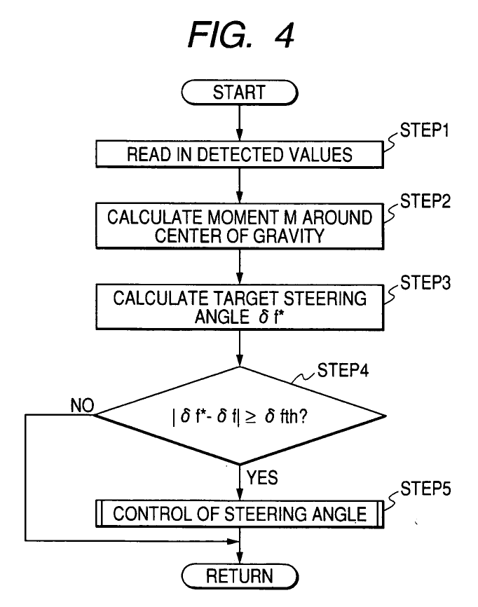

FIG. 4 is a flowchart illustrating a control routine associated with the present embodiment. Processing illustrated in the flowchart is called at given intervals of time and executed by the main control portion 30. First, at step 1, various detection values are read in. Examples of the detection values read in at the step 1 are lengthwise force Fx acting on each of the wheels 13fl-13rr, lateral force Fy, up-and-down force Fz, frictional coefficient μ of the road surface, vehicle speed v, yaw rate γ, and lateral acceleration (lateral G) Yg.

At step 2, the present value of the moment M around the vertical line passing through the center of gravity of the vehicle is calculated. The moment M around the center of gravity is uniquely calculated from the following equation based on the lengthwise force Fx at each of the wheels 13fl-13rr detected by the acting force detection portion 29.

$$M = \{ ( Fxfr + Fxrr ) - ( Fxfl + Fxrl ) \} \cdot ( \frac{Tr}{2} ) \qquad ( 1 )$$

where Fxfr, Fxrr, Fxrl, and Fxrl are the lengthwise forces Fx at the right front wheel 13fr, right rear wheel 13rr, left front wheel 13fl, and left rear wheel 13rl, respectively, and Tr is the tread. Where the vehicle is a front-wheel-drive vehicle, Eq. (1) is replaced by the following Eq. (2-1) Where the vehicle is a rear-wheel-drive vehicle, Eq. (1) is replaced by Eq. (2-2).

$$\begin{matrix}M = ( Fxfr - Fxfl ) \cdot ( \frac{Tr}{2} ) & \text{(2-1)} \\ M = ( Fxrr - Fxrl ) \cdot ( \frac{Tr}{2} ) & \text{(2-2)}\end{matrix}$$

At step 3, the target steering angle δf* of the wheel is calculated based on the calculated present value of the moment M around the center of gravity. The target steering angle δf* of the wheel is uniquely calculated from the following equation.

$$δ {f}^{*} = \frac{( lf \cdot kf - lr \cdot kr ) β}{lf \cdot kf} + \frac{Im \cdot s \cdot γ}{2 lf \cdot kf} + \frac{( {lf}^{2} \cdot kf - {lr}^{2} \cdot kr ) γ}{v ( lf \cdot kf )} + \frac{M}{2 lf \cdot kf} \qquad ( 3 )$$

Parameters used in Eq. (3) are given below.

Constants:

Im: yawing moment of inertia (kg-m²)

lf: distance (m) between the center of gravity of the vehicle and the front wheel axle

lr: distance (m) between the center of gravity of the vehicle and the rear wheel axle

kf: cornering power (N/rad) of the front wheels

kr: cornering power (N/rad) of the rear wheels

Variables:

β: Vehicle body lateral slip angle (rad)

γ: yaw rate (rad/s)

v: vehicle speed (m/s)

s: Laplace operator (derivative of yaw rate γ)
The vehicle body lateral slip angle β can be uniquely calculated from the following equation based on the lateral G Yg, vehicle speed v, and yaw rate γ:

$$β = \frac{Yg}{v \cdot s} - \frac{γ}{s} \qquad ( 4 )$$

The cornering power is the rate of change of the cornering force (the component of the frictional force produced at the road contact surface which is produced in a direction perpendicular to the direction of travel of a wheel when it rotates at some lateral slip angle βw) with respect to a minute change in the lateral slip angle βw of the wheel. Although the lateral force Fy and the cornering force are values not strictly in agreement, it can be practically regarded that these values are approximate to each other within the range of the wheel lateral slip angle βw that the vehicle can assume. Accordingly, where the cornering force and the lateral force Fy are regarded as substantially equivalent and the cornering power is considered based on the lateral force Fy, the cornering power can be uniquely identified from the lengthwise force Fx, lateral force Fy, up-and-down force Fx, and frictional coefficient μ of the road surface. One example of the technique for calculating the cornering power is disclosed in JP-A-2004-149107 to which reference can be made if necessary.

At step 4, the actual steering angle δf of the wheel and the target steering angle δf* of the wheel are compared and a decision is made as to whether control should be performed. In particular, a decision is made as to whether the absolute value of the difference between the target steering angle δf* of the wheel and the actual steering angle δf of the wheel is more than a given threshold value δfth for decision. This threshold value δfth has been previously set to an appropriate value through experiments or simulations. This appropriate value is a minimum value (min|1 δ*−δf|) of the difference between the two values, the difference being at a level that it is necessary to adjust the steering angle of the front wheels 13fl and 13fr, thus positively controlling the vehicular motion. At this step 4, if the decision is affirmative (i.e., the difference between them is more than the threshold value)., control goes to step 5. On the other hand, at step 4, if the decision is negative (i.e., the difference between them is less than the threshold value), control skips the step 5 and exits from the present routine.

At the step 5, a control of the steering angle of the wheel is carried out based on the target steering angle δf* of the wheel, and the control exits from the present routine. In particular, the target steering angle δf* of wheels calculated by the main control portion 30 is output to the secondary control portion 23 of the steer-by-wire mechanism. In the secondary control portion 23, the target steering angle δf* of the wheel is updated to a value computed by the main control portion 30. Based on this value, the steering angle of the wheel 13 is adjusted.

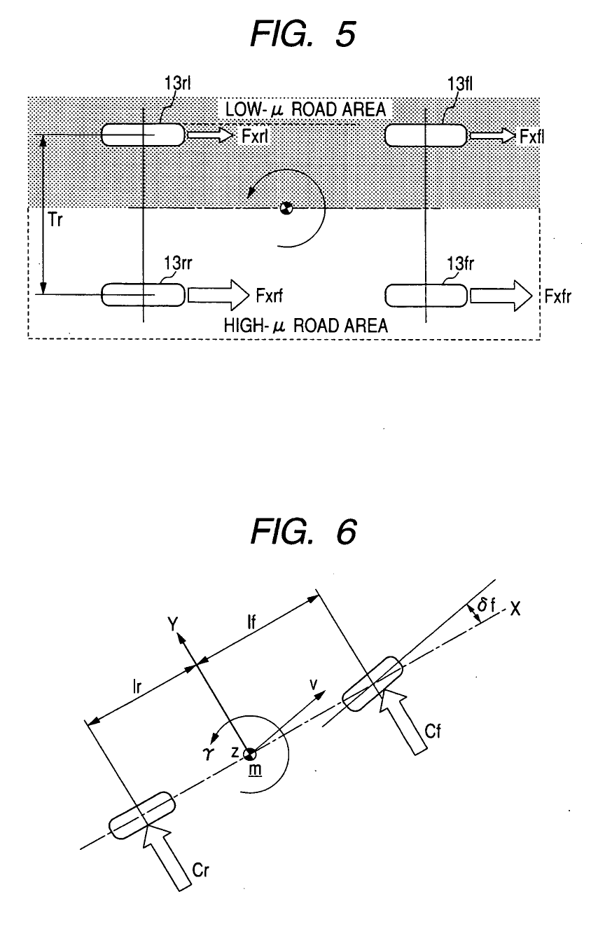

FIG. 5 is a diagram regarding the state of motion of a vehicle. A difference is produced in a driving force between the left wheels 13fl, 13rl and the right wheels 13fr, 13rr under circumstances where the road surface with which the left wheels 13fl and 13rl make contact and the road surface with which the right wheels 13fr and 13rr make contact are different in frictional coefficient μ (so-called split coefficient of friction). One example of the circumstances is that the right wheels 13fr and 13rr touch a dry asphalt road surface corresponding to a high-μ road surface and the left wheels 13fl and 13rl touch a compacted snow road surface corresponding to a low-μ road surface. In this case, the right wheels 13fr and 13rr on the high-μ road surface side are gripping the road surface, providing sufficient driving force. On the other hand, the left wheels 13fl and 13rl on the low-μ road surface side easily slip. Therefore, it is difficult to supply a sufficient driving force to the left wheels. Consequently, a difference is produced in the driving force between the left and right wheels 13. This generates the moment M around the center of gravity (see Eq. (1) above).

FIG. 6 is a diagram illustrating a vehicle model obtained by modeling the state of motion of a vehicle. This vehicle model has assumed that the vehicle is moving at constant speed in the X-axis direction. Only a rotary motion (yaw motion) around a vertical line (Z-axis) and a translational motion in a lateral direction (Y-axis direction), i.e., two degrees of freedom, are taken into consideration. That is, the model is a two-wheel model. Where the front wheels 13fl and 13fr are being steered (the rear wheels are parallel to the X-axis direction), the state of motion of the vehicle model is given by the following equations of motion (Eqs. (5-1) and (5-2)).

$$\begin{matrix}m \cdot v \cdot s \cdot β + 2 ( kf + kr ) β + \{ m \cdot v + \frac{2 ( lf \cdot kf - lr \cdot kr )}{v} \} γ = 2 kf \cdot δ f & \text{(5-1)} \\ 2 ( lf \cdot kf - lr \cdot kr ) β + I m \cdot s \cdot γ + \frac{2 ( {lf}^{2} \cdot kf - {lr}^{2} \cdot kr ) \cdot γ}{v} = 2 lf \cdot kf \cdot δ f & \text{(5-2)}\end{matrix}$$

where m is the mass (kg) of the vehicle, l is the length (m) of the wheel base, cf is the cornering force (N) of the front wheels, and cr is the cornering force (N) of the rear wheels. Where the moment M around the center of gravity due to a difference in driving force is taken into consideration in the vehicle motion model expressed in Eq. (5-2), Eq. (5-2) is modified into the form:

$$2 ( lf \cdot kf - lr \cdot kr ) β + Im \cdot s \cdot γ + \frac{2 ( {lf}^{2} \cdot kf - {lr}^{2} \cdot kr ) \cdot γ}{v} + M = 2 lf \cdot kf \cdot δ f \qquad ( 6 )$$

Where the vehicle runs on a road surface with a split coefficient of friction (especially, when the vehicle starts or brakes), the state of motion of the vehicle varies due to the moment M around the center of gravity due to a difference in the driving force. To suppress this variation, any parameter in Eq. (6) should be varied to produce a physical amount that is a component canceling the moment M around the center of gravity. In Eq. (6), the constants themselves cannot be varied. Therefore, only the variables are varied. However, of these variables, it is difficult to directly control the values of the vehicle body lateral slip angle β and of the cornering forces cf and cr of the front and rear wheels. Therefore, the vehicle speed v and the steering angle δf of the wheel are discussed. Although it is easy to control the vehicle speed v, there is the possibility that the control of the vehicle speed v contradicts driver's intention, for example, to increase or decrease the speed. Consequently, in many cases, the driver gets an unnatural feeling in performing the control to accelerate or decelerate the vehicle. Accordingly, in the present embodiment, the steering angle δf of the wheel 13 is controlled. Solving Eqs. (5-1) and (5-2) with respect to the steering angle δf of the wheel uniquely identifies the target steering angle δf* of the wheel that becomes a component canceling the moment M around the center of gravity due to a difference in the driving force.

In this way, according to the present embodiment, the lengthwise force Fx applied to the wheel 13 is first detected using the acting force detection portion 29 that directly detects the force acting on the wheel 13. Based on the detected lengthwise force Fx, the moment M around the center of gravity due to a difference in the driving force is calculated. If necessary, the steering angle δf of the wheel (in the present embodiment, the front wheels 13fl and 13fr) is controlled such that the moment M is reduced down to zero. Because of the adjustment of the steering angle δf of the wheel, a moment M that is a component opposite to the moment M around the center of gravity due to a difference in the driving force acts on the vehicle. Therefore, the state of motion of the vehicle can be stabilized even under circumstances of vehicular operation of split-μ. Furthermore, the state of motion is stabilized and, at the same time, generation of the phenomenon that the steering wheel is undesirably turned due to a difference in the driving force is suppressed, by adopting a steer-by-wire mechanism in the steering mechanism of the vehicle and modifying the steering angle δf of the wheel.

In addition, in the present embodiment, the lengthwise force Fx acting on the wheel 13 is directly detected by the acting force detection portion 29. Therefore, the moment M around the center of gravity can be identified more precisely than where the lengthwise force Fx is estimated or where the force is detected using an indirect technique. Additionally, the lengthwise force Fx can be accurately identified, for example, in a nonlinear region of the wheel, as well as in a linear region. This makes it possible to accurately calculate the moment M around the center of gravity due to a difference in driving force. In consequence, the reliability of the control can be enhanced.

It is to be noted that in the present embodiment, the target steering angle δf* of the wheel 13 that is a controlled variable is calculated based on the equations of motion of the vehicle such that the moment M around the center of gravity becomes null. However, from a viewpoint of stability of control, the amount of control of the wheel 13 relative to the target steering angle δf* of the wheel may be set to a value that controls the steering angle δf of the wheel by an amount corresponding to a given incremental value. In this case, unnatural feeling created in providing control can be alleviated. In addition, by continuing the present routine, the steering angle δf of the wheel 13 is made to converge to the target steering angle δf* of the wheel by the action of incremental values. Consequently, the same advantages as the aforementioned advantages can be obtained. In other words, it is only necessary to set the target steering angle δf* of the wheel such that the moment M around the center of gravity produced around the vehicle approaches 0 from the present value.

In the above embodiment, the vehicle speed v is used as a parameter in calculating the target steering angle δf* of the wheel. The vehicle speed v can be uniquely identified as the average value of the speed values detected by the vehicle speed sensors 27 mounted to the wheels 13fl-13rr, respectively. However, under circumstances of split-μ, for example, the actual vehicle speed may be different from the detected speed value. In particular, when the vehicle starts, there is a possibility that the wheel 13 on the low-μ road surface side is slipping. Therefore, the target steering angle δf* of the wheel may be calculated using the speed of the wheel gripping the road surface most effectively, i.e., the minimum speed value vₘᵢₙ of the speeds of the wheels 13fl-13rr. On the other hand, during braking, there is a possibility that some wheels may lock. Therefore, the target steering angle δf* of the wheel may be calculated using the speed of unlocking wheels, i.e., the maximum speed value vₘₐₓ of the speeds of the wheels 13fl-13rr.

### Second Embodiment

In the first embodiment described above, the values of the body lateral slip value β and yaw rate y are directly detected by sensors in calculating the target steering angle δf*. Alternatively, the angle is calculated based on detected values. Body lateral slip value β and yaw rate y produced on an actual vehicle are negligibly small in calculating the target steering angle δf* of the wheel. Accordingly, in the present embodiment, these values are neglected. Eq. (3) is approximated by a simple algebraic formula given by Eq. (7). Thus, the target steering angle δf* is identified. Fundamental portions regarding the whole system configuration, control of the road wheel angles, and control of the steering torque are the same as their counterparts of the first embodiment and so their description is omitted herein.

$$δ f = \frac{M}{2 lf \cdot kf} \qquad ( 7 )$$

According to the present embodiment, a vehicle model is approximated, thus reducing the number of parameters constituting the vehicle model. For example, the algebraic formula (7) is used for this purpose. Then, the target steering angle δf* of the wheel is calculated. Consequently, the same advantages as the advantages of the first embodiment are obtained. In addition, sensors (e.g., yaw rate sensor, vehicle speed sensors, and lateral speed sensor) other than the acting force detection portion 29 are made unnecessary. Therefore, the configuration of the apparatus can be made simpler. Additionally, the cost can be reduced.

What is claimed is:

1. A vehicular motion control apparatus comprising:
a detection portion for detecting lengthwise forces respectively acting on left wheel and right wheel of a vehicle;
a calculation portion for calculating a present value of a moment around a vertical line passing through the center of gravity of the vehicle based on the detected lengthwise forces, the moment being produced around the vehicle due to a difference in a driving force between the left wheel and right wheel;
a setting portion for identifying a steering angle of said wheel varying state of motion of the vehicle such that said moment produced around the vehicle approaches 0 from the calculated present value and setting the identified steering angle of said wheel as a target steering angle of said wheel; and
a wheel control portion for controlling the steering angle of said wheel based on the set target steering angle.

2. The vehicular motion control apparatus as set forth in claim 1, wherein said setting portion has parameters including at least said steering angle, and wherein a steering angle that becomes a component canceling the present value of said moment is calculated as said target steering angle based on a vehicle model obtained by modeling state of motion of said vehicle.

3. The vehicular motion control apparatus as set forth in claim 2, wherein said setting portion calculates said target steering angle using an algebraic formula in which the number of parameters constituting said vehicle model has been reduced by approximating the vehicle model.

4. The vehicular motion control apparatus as set forth in claim 2, further including a wheel speed sensor for detecting speed of said wheel as one kind of the parameters constituting said vehicle model,
wherein said setting portion calculates said target steering angle using a maximum speed value of speeds detected by said wheel sensor when said vehicle is braking, and calculates said target steering angle using a minimum speed value of the speeds detected by said wheel sensor when the vehicle starts.

5. A method of controlling motion of a vehicle, said method comprising:
a first step of detecting lengthwise forces respectively acting on left wheel and right wheel mounted to the vehicle;
a second step of calculating a present value of a moment around a vertical line passing through the center of gravity of the vehicle based on the detected lengthwise forces, the moment being produced around the vehicle by a difference between driving forces respectively acting on the left wheel and right wheel;
a third step of identifying a steering angle of said wheels varying state of motion of the vehicle such that said moment produced around the vehicle approaches 0 from the calculated present value and setting the identified steering angle as a target steering angle; and
a fourth step of controlling the steering angle of said wheel based on the set target steering angle.
